(19) United States
(12) Patent Application Publication
(10) Pub. No.: US 2008/0298561 A1
(43) Pub. Date: Dec. 4, 2008

(54) Web-call method

(75) Inventors: Shaw-Hwa Hwang, Taipei (TW); Shun-Chieh Chang, Taipei (TW); Chi-Jung Huang, Taipei (TW); Hsiao-Chang Chang, Taipei (TW); Yen-Chun Huang, Taipei (TW); Sheng-Yang Tsai, Taipei (TW); Chun-Chi Fan, Taipei (TW); Yu-Chen Tu, Taipei (TW); Yu-Che Wang, Taipei (TW); Yao-Chang Chung, Taipei (TW)

Correspondence Address: BACON & THOMAS, PLLC, 625 SLATERS LANE, FOURTH FLOOR, ALEXANDRIA, VA, 22314-1176, US

(73) Assignee: Color City Enterprise Co., Ltd., Apia (WS)

(21) Appl. No.: 11/802,948

(22) Filed: May 29, 2007

(51) Int. Cl. H04L 12/66; H04M 1/64

(52) U.S. Cl. 379/88.17; 370/352; 370/401; 709/227

(57) ABSTRACT

The present invention provides a web call method so that when a user uses a personal computer to make an Internet call, the user just inputs a web address through browser instead of key in telephone number by keyboard. It comprises steps as below:

At first a web server is established, and the web server can set up a web page for each telephone number;

User A registers a “user A's telephone number” on the web server, the web server sets up a web page for user A, and design a program to input “user A's telephone number” into an Active-X element;

Another user B uses a personal computer to input web address containing user A's telephone number through Internet browser, thereby to communicate with the web server; then the web server downloads the Active-X element having “user A's telephone number” to user B's personal computer;

User B's personal computer then automatically uses the Active-X element having “user A's telephone number” for dialing “user A's telephone number” to a VoIP server;

The VoIP server will then connect “user A's telephone number” for user B.

### FIELD OF THE INVENTION

The present invention relates to a web-call method, and more particularly to a web-call method via browser by inputting web address.

### BACKGROUND OF THE INVENTION

It is comparatively cheap to make a phone call through the Internet, and that's why the Internet phone is popular. The internet phone uses VoIP (Voice over Internet Protocol) related software, and installs the VoIP related software into a personal computer, microphone and earphone/speaker are also installed on the personal computer, after the personal computer is connected with the Internet, then a user keys in a telephone number by keyboard, thereby to communicate through a VoIP server with other people.

Since the Internet phone with VoIP related software is existed, an “Internet communication center” can be further designed to assist the users to make a web-call via browser by inputting web address.

### SUMMARY OF THE INVENTION

The object of the present invention is to provide a web call method so that when a user uses personal computer to make an Internet call, the user just inputs a web address through browser instead of key in telephone number by keyboard. The web call comprises the steps as below:

At first, a web server is established, suppose the web address thereof is http://SoPhone.com, and the web server can set up a web page for each telephone number;

User A registers a “user A's telephone number” on the web server, the web server sets up a web page for user A, with web address http://SoPhone.com/user A's telephone number, and design a program CallOut.htm to input “user A's telephone number” into an Active-X element;

Another user B uses a personal computer to input web address http://SoPhone.com/user A's telephone number through Internet browser, thereby to communicate with the web server; the web server transfers http://SoPhone.com/user A's telephone number into http://SoPhone.com/CallOut.htm?id=user A's telephone number, and instructs program CallOut.htm to download the Active-X element having “user A's telephone number” to user B's personal computer;

User B's personal computer then automatically use the Active-X element having “user A's telephone number” to dial “user A's telephone number” to a VoIP server;

The VoIP server will then connect “user A's telephone number” for user B; if “user A's telephone number” is not a web telephone number, then the VoIP server will connect for user B a public telephone or a mobile phone via a VoIP gateway;

When user B calls user A again, the web address http://SoPhone.com/user A's telephone number is inputted through Internet browser, since user B's personal computer has contained the Active-X element having “user A's telephone number”, therefore User B's personal computer automatically use the Active-X element having “user A's telephone number” to dial user A's telephone number via the VoIP server;

If user A registers a “user A's telephone number-extension number” on the web server, then user B inputs the web address http://SoPhone.com/user A's telephone number-extension number via Internet browser to dial user A's telephone number, the Active-X element in user B's personal computer will then dial “extension number” automatically to the extension number phone of user A;

If user A registers the “user A's telephone number” on the web server, and also registers “user A's name”, then the web page of user A in web server will set up a linkage relation between “user A's name” and “user A's telephone number”; thereafter if user B inputs the web address http://SoPhone.com/user A's name via Internet browser, program CallOut.htm will input “user A's name” and “user A's telephone number” to the Active-X element and download the Active-X element to user B's personal computer for user B to dial the “user A telephone number”;

If user B inputs the web address http://SoPhone.com/, it means that user B calls the web server as an “Internet communication center”, then the web server will download an Active-X element having the telephone number of the web server to user B's personal computer for user B to dial.

### BRIEF DESCRIPTION OF THE DRAWING

FIG. 1 shows a flow chart of the web call method according to the present invention.

### DETAILED DESCRIPTION OF THE PREFERRED EMBODIMENT

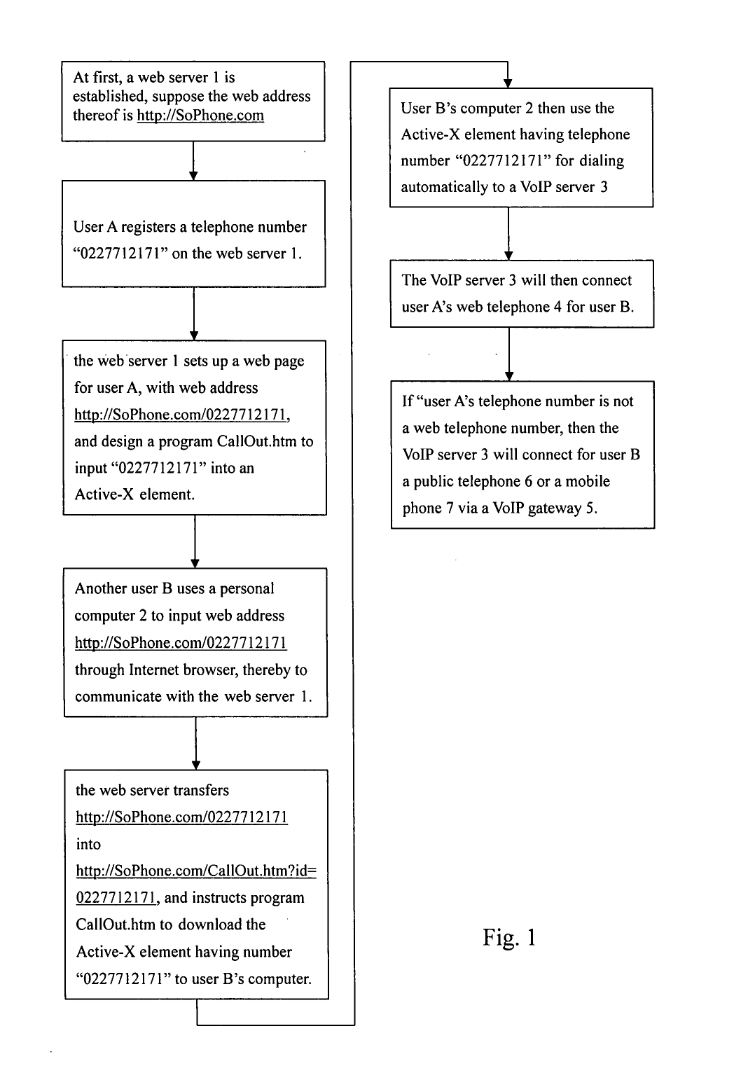

Referring to FIG. 1, which is a flow chart of the web call method according to the present invention.

At first, a web server 1 is established, suppose the web address thereof is http://SoPhone.com, the web server acts as an “Internet communication center”, and can set up a web page for each telephone number;

User A registers a telephone number “0227712171” on the web server 1, the web server 1 sets up a web page for user A, with web address http://SoPhone.com/0227712171, and design a program CallOut.htm to input the telephone number “0227712171” into an Active-X element;

Another user B uses a personal computer 2 to input web address http://SoPhone.com/0227712171 through Internet browser, thereby to communicate with the web server 1; the web server transfers http://SoPhone.com/0227712171 into http://SoPhone.com/CallOut.htm?id=0227712171, and instructs program CallOut.htm to download the Active-X element having telephone number “0227712171” to user B's personal computer 2;

User B's personal computer 2 then automatically use the Active-X element having telephone number “0227712171” for dialing to a VoIP server 3;

The VoIP server 3 will then connect user A's web telephone 4 for user B; if “user A's telephone number is not a web telephone number, then the VoIP server 3 will connect for user B a public telephone 6 or a mobile phone 7 via a VoIP gateway 5;

When user B calls user A again, the web address http://SoPhone.com/0227712171 is inputted through Internet browser, since user B's personal computer has contained the Active-X element having telephone number “0227712171”, therefore User B's personal computer automatically dials user A's telephone via the VoIP sever 3;

If user A registers “0227712171-2178” on the web server, “2178” is the extension number, then user B inputs the web address http://SoPhone.com/0227712171-2178 via Internet browser to dial user A's telephone number 0227712171, the Active-X element in user B's personal computer 2 will then dial “2178” automatically to the extension number phone of user A;

If user A registers the telephone number “0227712171” on the web server, and also registers a name “John Wang”, then the web page of user A in web server 1 will set up a linkage relation between “John Wang” and “0227712171”; thereafter if user B inputs the web address http://SoPhone.com/John Wang via Internet browser, program CallOut.htm will input “John Wang” and “0227712171” to the Active-X element and download the Active-X element to user B's personal computer 2 for user B to dial the telephone number “0227712171”;

If user B inputs the web address http://SoPhone.com/, it means that user B calls the web server 1 as an “Internet communication center”, then the web server 1 will download an Active-X element having the telephone number of the web server 1 to user B's personal computer 2 for user B to dial.

If user B inputs the web address http://0227712171.SoPhone.com/, it means that user B inputs the web address http://SoPhone.com/0227712171.

The web server 1 acts as an “Internet communication center” to accept many people to register telephone numbers so that many people can communicate each other by inputting web address containing telephone number via Internet browser.

The scope of the present invention depends upon the following claims, and is not limited by the above embodiment.

What is claimed is:

1. A web-call method, comprising steps as below:
a. a web server is established, suppose the web address thereof is http://SoPhone.com, and the web server can set up a web page for each telephone number;
b. a user A registers a “user A's telephone number” on the web server, the web server sets up a web page for user A, with web address http://SoPhone.com/user A's telephone number, and design a program CallOut.htm to input “user A's telephone number” into an Active-X element;
c. another user B uses a personal computer to input web address http://SoPhone.com/user A's telephone number through Internet browser, thereby to communicate with the web server; the web server transfers http://SoPhone.com/user A's telephone number into http://SoPhone.com/CallOut.htm?id=user A's telephone number, and instructs program CallOut.htm to download the Active-X element having “user A's telephone number” to user B's personal computer;
d. user B's personal computer then automatically uses the Active-X element having “user A's telephone number” for dialing “user A's telephone number” to a VoIP server;
e. the VoIP server will then connect “user A's telephone number” for user B; if “user A's telephone number” is not a web telephone number, then the VoIP server will connect for user B a public telephone or a mobile phone via a VoIP gateway.

2. The web call method according to claim 1, wherein when user B calls user A again, the web address http://SoPhone.com/user A's telephone number is inputted through Internet browser, since user B's personal computer has contained the Active-X element having “user A's telephone number”, therefore user B's personal computer automatically uses the Active-X element having “user A's telephone number” to dial user A's telephone number via the VoIP sever.

3. The web call method according to claim 1, wherein if user A registers a “user A's telephone number-extension number” on the web server, then user B inputs the web address http://SoPhone.com/user A's telephone number-extension number via Internet browser to dial user A's telephone number, the Active-X element in user B's personal computer will then dial “extension number” automatically to an extension number phone of user A.

4. The web call method according to claim 1, wherein if the user A registers the “user A's telephone number” on the web server, and also registers “user A's name”, then the web page of user A in web server will set up a linkage relation between “user A's telephone number” and “user A's name”; thereafter if user B inputs the web address http://SoPhone.com/user A's name via Internet browser, program CallOut.htm will input “user A's telephone number” and “user A's name” to the Active-X element and download the Active-X element to user B's personal computer for user B to dial the “user A's telephone number”.

5. The web call method according to claim 1, wherein if user B inputs the web address http://SoPhone.com/, it means that the second user calls the web server as an “Internet communication center”, then the web server will download an Active-X element having the telephone number of the web server to user B's personal computer for user B to dial.

6. The web call method according to claim 1, wherein if user B inputs the web address http://user A's telephone number.SoPhone.com/, it means that user B inputs the web address http://SoPhone.com/user A's telephone number.
